(19) United States
(12) Patent Application Publication
(10) Pub. No.: US 2016/0028480 A1
(43) Pub. Date: Jan. 28, 2016

(54) OPTICAL TRANSMISSION SYSTEM, OPTICAL TRANSMITTER, OPTICAL RECEIVER, AND OPTICAL TRANSMISSION METHOD

(71) Applicant: NEC CORPORATION, Minato-ku, Tokyo (JP)

(72) Inventors: Toshiharu ITO, Tokyo (JP); Emmanuel LE TAILLANDIER DE GABORY, Tokyo (JP)

(73) Assignee: NEC CRPORATION

(21) Appl. No.: 14/774,784

(22) PCT Filed: Mar. 11, 2014
(86) PCT No.: PCT/JP2014/056318

§ 371 Date: Sep. 11, 2015

(30) Foreign Application Priority Data
Mar. 14, 2013 (JP) 2013-051842

(51) Int. Cl. H04B 10/2507; H04B 10/556; H04B 10/61

(52) U.S. Cl. CPC H04B 10/2507; H04B 10/6165; H04B 10/5561

(57) ABSTRACT

An optical transmitter (10) outputs basic transmission light of an optical signal for transmission to an optical receiver (20). A first optical signal generation means (210) of the optical receiver (20) receives the optical signal for transmission, and generates a first optical signal by causing the received optical signal for transmission and locally generated light to interfere with each other. A second optical signal generation means (220) of the optical receiver (20) receives the transmission light, and generates an optical signal for denoising by causing the received transmission light and the locally generated light to interfere with each other. A first photoelectric conversion means (230) of the optical receiver (20) photoelectrically converts the first optical signal to generate a received signal. A second photoelectric conversion means (240) photoelectrically converts the optical signal for denoising to generate a noise signal. A denoising means (250) removes a noise component from the received signal using the noise signal.

### TECHNICAL FIELD

The present invention relates to an optical transmission system, an optical transmitter, an optical receiver, and an optical transmission method.

### BACKGROUND ART

The amount of data communicated has increased with the spread of the Internet. In order to cope with this trend, it is necessary to increase the capacity of a transmission channel. One of techniques for realizing an increase in capacity includes a quadrature amplitude modulation (QAM) system. Optical signals on which modulation of a QAM system is performed in a transmitter are demodulated in an optical receiver of a digital coherent system.

On the other hand, Non-Patent Document 1 discloses that transmission light on which an optical signal is based on is branched, and then one piece of the branched light is modulated to generate an optical signal, the generated optical signal is transmitted to a receiving side, and the other piece of the branched light is transmitted to the receiving side without performing modulation. In the receiving side, transmission light transmitted without being modulated is used as locally generated light. According to such a method, it is possible to reduce the number of light sources. In addition, in Non-Patent Document 1, the optical signal and the transmission light are transmitted using the same multi-core fiber.

Meanwhile, Patent Document 1 discloses that, in optical heterodyne detection, a phase fluctuation included in the optical signal is detected by the action of the optical signal on the locally generated light, and noise of the optical signal is removed using the detected phase fluctuation.

### RELATED DOCUMENTS

### Patent Document

[Patent Document 1] Japanese Unexamined Patent Application Publication No. 62-10936

### Non-Patent Document

[Non-Patent Document 1] Benjamin J. Puttnam et al., “Investigating Self-Homodyne Coherent Detection in a 19-core Spatial-Division-multiplexed Transmission Link”, Tu.3.C.3, ECOC2012, Amsterdam, 2012

### SUMMARY OF THE INVENTION

In optical communication, a large problem of noise included in an optical signal occurs. Noise components added in a transmission channel can be removed to some extent by using an optical filter. However, there is a limit to the narrowing of the passband of the optical filter. Moreover, since phase modulation is used in a digital coherent system, in addition to noise added in the transmission channel, noise (phase noise) included in transmission light before modulation and locally generated light also serves as a factor for a deterioration in signal quality.

An object of the present invention is to provide an optical transmission system, an optical transmitter, an optical receiver, and an optical transmission method which are capable of removing noise caused by each of transmission light before modulation and locally generated light.

According to the present invention, there is provided an optical transmission system including: an optical transmitter that generates an optical signal for transmission to output the generated signal to the outside; and an optical receiver that receives the optical signal for transmission, wherein the optical transmitter includes an optical branching unit that branches transmission light for generating the optical signal for transmission into at least two pieces, an optical signal generation unit that generates the optical signal for transmission by modulating at least one piece of the transmission light after the branching, a first optical output unit that outputs the optical signal for transmission to the outside, and a second optical output unit that outputs one piece of the transmission light after the branching to the outside without performing modulation thereon, and the optical receiver includes a first optical signal generation unit that receives the optical signal for transmission, and generates a first optical signal by causing the received optical signal for transmission and locally generated light to interfere with each other, a second optical signal generation unit that receives the transmission light, and generates an optical signal for denoising by causing the received transmission light and the locally generated light to interfere with each other, a first photoelectric conversion unit that photoelectrically converts the first optical signal to generate a received signal, a second photoelectric conversion unit that photoelectrically converts the optical signal for denoising to generate a noise signal, and a denoising unit that removes a noise component from the received signal using the noise signal.

According to the present invention, there is provided an optical transmitter including: an optical branching unit that branches transmission light for generating an optical signal into at least two pieces; an optical signal generation unit that generates an optical signal for transmission by modulating at least one piece of the transmission light after the branching; a first optical output unit that outputs the optical signal generation unit to the outside; and a second optical output unit that outputs one piece of the transmission light after the branching to the outside without performing modulation.

According to the present invention, there is provided an optical receiver including: a first optical signal generation unit that receives an optical signal for transmission, generated by modulating transmission light, from an outside, and generates a first optical signal by causing the received optical signal for transmission and locally generated light to interfere with each other; a second optical signal generation unit that receives the transmission light from an outside, and generates an optical signal for denoising by causing the received transmission light and the locally generated light to interfere with each other; a first photoelectric conversion unit that photoelectrically converts the first optical signal to generate a received signal; a second photoelectric conversion unit that photoelectrically converts the optical signal for denoising to generate a noise signal; and a denoising unit that removes a noise component from the received signal using the noise signal.

According to the present invention, there is provided an optical transmission method including: in an optical transmitter, branching transmission light for generating an optical signal for transmission into at least two pieces; generating the optical signal for transmission by modulating at least one piece of the transmission light after the branching, and outputting the generated optical signal for transmission to an optical receiver; outputting one piece of the transmission light after the branching to the optical receiver without performing modulation thereon; and in the optical receiver, receiving the optical signal for transmission, and generating a first optical signal by causing the received optical signal for transmission and locally generated light to interfere with each other; receiving the transmission light, and generating an optical signal for denoising by causing the received transmission light and the locally generated light to interfere with each other; photoelectrically converting the first optical signal to generate a received signal; photoelectrically converting the optical signal for denoising to a generate noise signal; and removing a noise component from the received signal using the noise signal.

According to the present invention, it is possible to remove noise caused by each of transmission light before modulation and locally generated light.

### BRIEF DESCRIPTION OF THE DRAWINGS

The above-mentioned objects, other objects, features and advantages will be made clearer from the preferred exemplary embodiments described below, and the following accompanying drawings.

FIG. 1 is a diagram illustrating a configuration of an optical transmission system according to a first exemplary embodiment.

FIG. 2 is a diagram illustrating a functional configuration of an optical transmitter.

FIG. 3 is a diagram illustrating a functional configuration of an optical receiver.

FIG. 4 is a diagram illustrating a configuration of an optical transmission system according to a second exemplary embodiment.

FIG. 5 is a diagram illustrating a configuration of an optical transmission system according to a third exemplary embodiment.

FIG. 6 is a diagram illustrating a configuration of an optical transmission system according to a fourth exemplary embodiment.

FIG. 7 is a diagram illustrating a functional configuration of a denoised signal generation unit according to a fifth exemplary embodiment.

FIG. 8 is a diagram illustrating a functional configuration of an optical signal processing unit according to the fifth exemplary embodiment.

FIG. 9 is a diagram illustrating a functional configuration of a denoised signal generation unit according to a sixth exemplary embodiment.

FIG. 10 is a diagram illustrating a functional configuration of an optical signal processing unit according to the sixth exemplary embodiment.

### DESCRIPTION OF EXEMPLARY EMBODIMENTS

Hereinafter, exemplary embodiments of the present invention will be described with reference to the accompanying drawings. In all the drawings, like elements are referenced by like reference numerals and the descriptions thereof will not be repeated.

### First Exemplary Embodiment

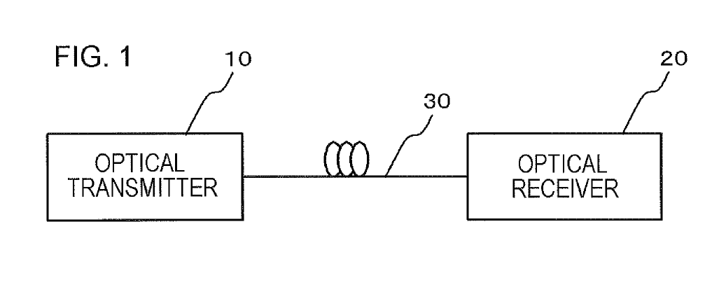

FIG. 1 is a diagram illustrating a configuration of an optical transmission system according to a first exemplary embodiment. The optical transmission system according to the present exemplary embodiment includes an optical transmitter 10 and an optical receiver 20. The optical transmitter 10 and the optical receiver 20 are connected to each other using a transmission channel 30. The transmission channel 30 is configured using, for example, an optical fiber. The optical transmitter 10 generates an optical signal for transmission and outputs the generated signal to the outside. The optical receiver 20 receives an optical signal for transmission through the transmission channel 30. Communication between the optical transmitter 10 and the optical receiver 20 is performed using, for example, a digital coherent system.

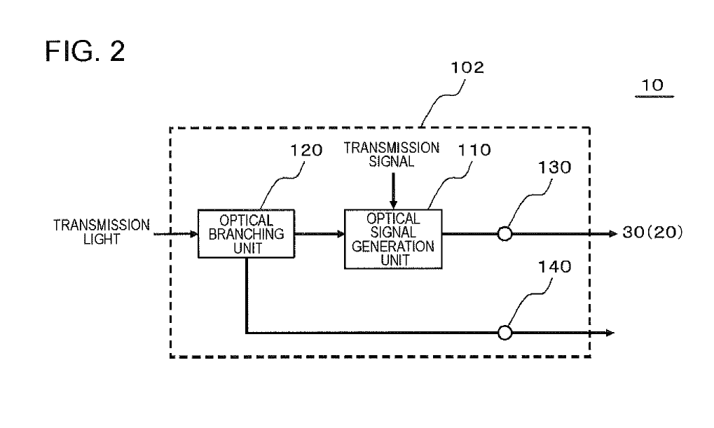

FIG. 2 is a diagram illustrating a functional configuration of the optical transmitter 10. The optical transmitter 10 includes at least one optical transmission unit 102. The optical transmission unit 102 includes an optical signal generation unit 110, an optical branching unit 120, a first optical output unit 130, and a second optical output unit 140. The optical branching unit 120 branches transmission light for generating an optical signal for transmission into at least two pieces. The optical signal generation unit 110 modulates at least one piece of the transmission light after the branching, to thereby generate an optical signal for transmission. In an example shown in the drawing, the optical branching unit 120 branches the transmission light into two pieces. One piece of the transmission light after the branching is modulated by the optical signal generation unit 110. The optical signal generation unit 110 modulates the transmission light using a plurality of signals to be transmitted, to thereby generate an optical signal for transmission on which polarization multiplexing and quadrature amplitude modulation are performed.

The first optical output unit 130 outputs the optical signal for transmission to the outside. The second optical output unit 140 outputs one piece of the transmission light after the branching to the outside without performing modulation thereon. Meanwhile, the transmission light which is output herein is a single type of polarized light.

Meanwhile, when the transmission channel 30 is formed using a multi-core optical fiber, it is preferable that the optical signal for transmission and the transmission light are transmitted through cores different from each other.

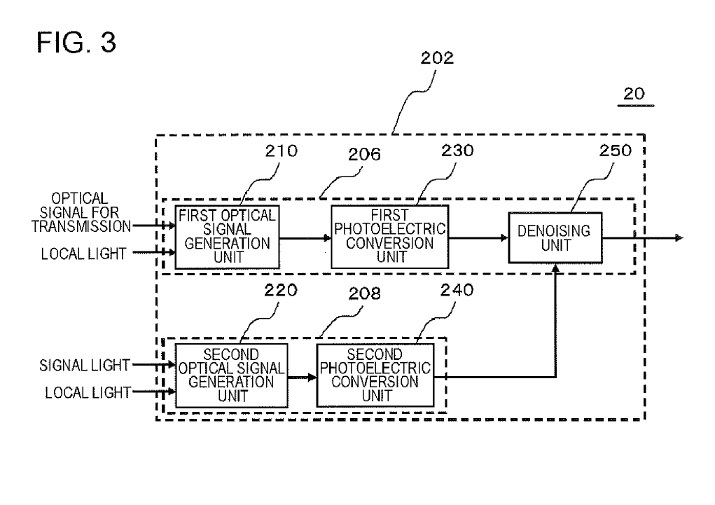

FIG. 3 is a diagram illustrating a functional configuration of the optical receiver 20. The optical receiver 20 includes a first optical signal generation unit 210, a second optical signal generation unit 220, a first photoelectric conversion unit 230, a second photoelectric conversion unit 240, and a denoising unit 250. The first optical signal generation unit 210, the first photoelectric conversion unit 230, and the denoising unit 250 are at least a portion of an optical signal processing unit 206, and the second optical signal generation unit 220 and the second photoelectric conversion unit 240 are at least a portion of a denoised signal generation unit 208.

The first optical signal generation unit 210 receives the optical signal for transmission, and generates a first optical signal by causing the received optical signal for transmission and locally generated light (local light) to interfere with each other. The second optical signal generation unit 220 receives transmission light (signal light), and generates an optical signal for denoising by causing the received transmission light and the locally generated light to interfere with each other. The locally generated light which is used in the second optical signal generation unit 220 is emitted from the same light source as that of the locally generated light which is used in the first optical signal generation unit 210.

The first photoelectric conversion unit 230 photoelectrically converts the first optical signal and generates a received signal. The second photoelectric conversion unit 240 photoelectrically converts the optical signal for denoising and generates a noise signal. The denoising unit 250 removes a noise component from the received signal using the noise signal.

Meanwhile, the optical transmission system may have a combination of the optical transmission unit 102 and the transmission light source 104 by each of a plurality of wavelengths. In this case, the optical transmitter 10 is provided with a wavelength multiplexer at each of between the first optical output unit 130 and the transmission channel 30, and between the second optical output unit 140 and the transmission channel 30. In addition, a wavelength demultiplexer is provided at each of between the first optical signal generation unit 210 and the transmission channel 30, and between the second optical signal generation unit 220 and the transmission channel 30.

According to the present exemplary embodiment, the optical transmitter 10 outputs transmission light on which the optical signal for transmission is based on to the optical receiver 20. The optical receiver 20 generates an optical signal for denoising by causing the locally generated light and the transmission light to interfere with each other. The transmission light is transmitted through the transmission channel 30. For this reason, the optical signal for denoising includes a noise component caused by each of the transmission light and the transmission channel 30. In addition, the locally generated light is also used in generating the optical signal for denoising. Therefore, the optical signal for denoising also includes a noise component caused by the locally generated light. Therefore, when denoising is performed using the optical signal for denoising, it is possible to remove noise caused by the transmission channel, noise caused by the transmission light, and noise caused by the locally generated light.

### Second Exemplary Embodiment

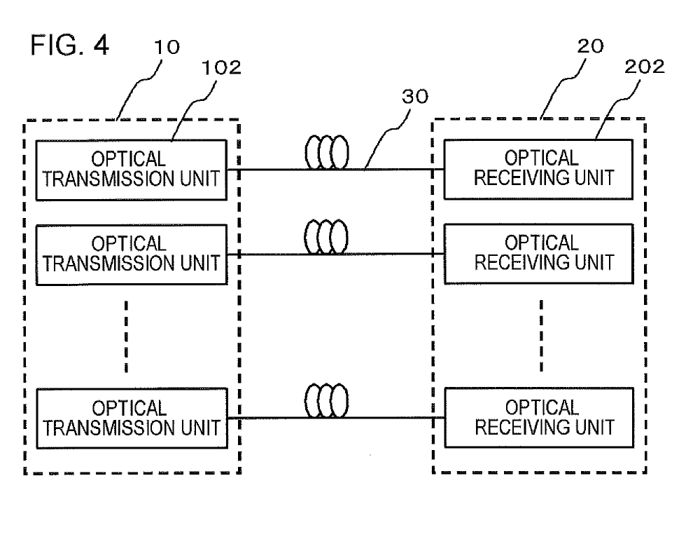

FIG. 4 is a diagram illustrating a configuration of an optical transmission system according to a second exemplary embodiment. The optical transmission system according to the present exemplary embodiment has the same configuration as that of the optical transmission system shown in the first exemplary embodiment, except for the following points.

First, an optical transmitter 10 includes a plurality of optical transmission units 102. In addition, an optical receiver 20 includes a plurality of optical receiving units 202. The respective optical transmission units 102 are connected to optical receiving units 202 different from each other through transmission channels 30 different from each other.

In the present exemplary embodiment, it is also possible to obtain the same effect as that in the first exemplary embodiment.

### Third Exemplary Embodiment

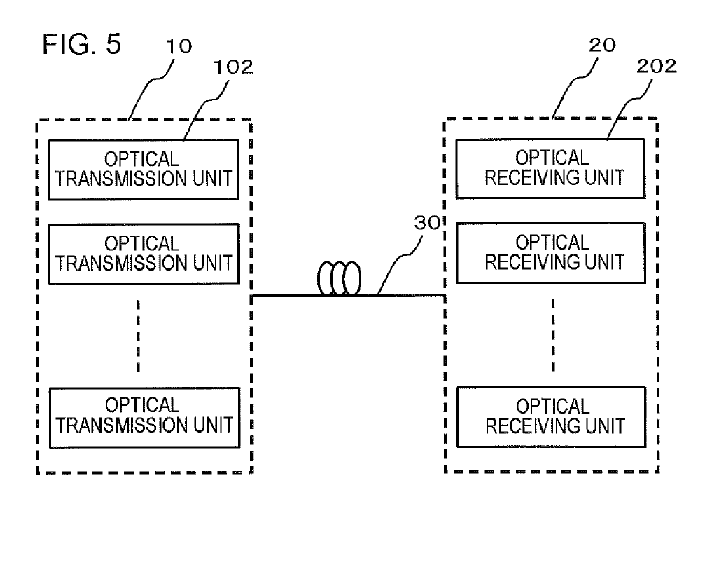

FIG. 5 is a diagram illustrating a configuration of an optical transmission system according to a third exemplary embodiment. The optical transmission system according to the present exemplary embodiment has the same configuration as that of the optical transmission system according to the second exemplary embodiment, except for the following points.

First, a transmission channel 30 is formed using a multi-core optical fiber. An optical signal for transmission and transmission light are output from each of a plurality of optical transmission units 102, but a plurality of optical signals for transmission and pieces of transmission light are transmitted to an optical receiver 20 through cores different from each other.

In the present exemplary embodiment, it is also possible to obtain the same effect as that in the second exemplary embodiment. In addition, since the transmission channel 30 is formed using a multi-core optical fiber, it is possible to reduce the number of optical fibers constituting the transmission channel 30.

### Fourth Exemplary Embodiment

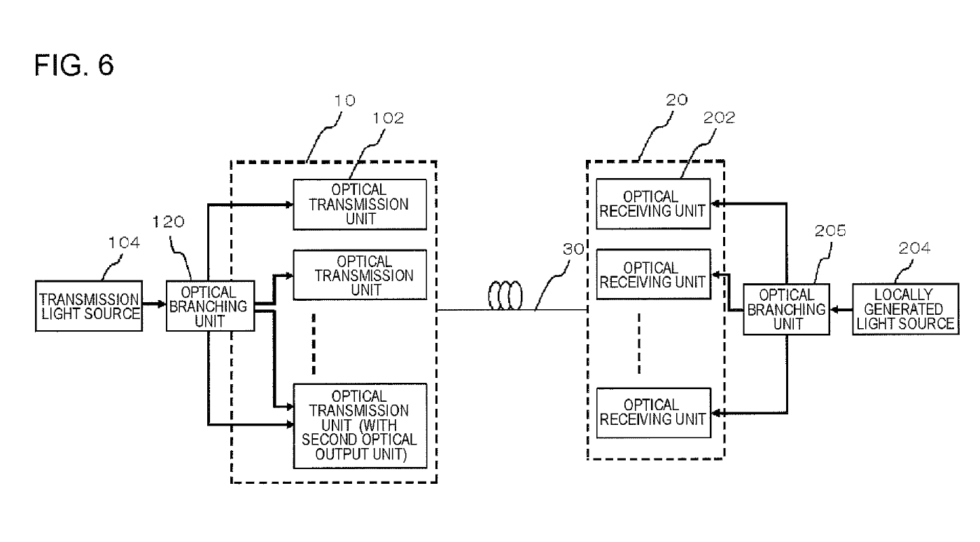

FIG. 6 is a diagram illustrating a configuration of an optical transmission system according to a fourth exemplary embodiment. The optical transmission system according to the present exemplary embodiment has the same configuration as that of the optical transmission system according to the second or third exemplary embodiment, except for the following points. The drawing illustrates the same case as in the third exemplary embodiment.

First, a plurality of optical transmission units 102 of an optical transmitter 10 share one transmission light source 104. Specifically, none of the plurality of optical transmission units 102 includes the optical branching unit 120. The optical branching unit 120 is provided outside the optical transmission units 102. The optical branching unit 120 branches transmission light emitted by the transmission light source 104 into a plurality of pieces of transmission light. The number of branches is at least three or more, and is one more than the number of optical transmission units 102. The pieces of the transmission light after the branching are incident on optical transmission units 102 different from each other, except for one piece.

In addition, the plurality of optical transmission units 102 do not include a second optical output unit 140, except for one optical transmission unit 102. In other words, the second optical output unit 140 is provided to only one optical transmission unit 102. One of the remaining pieces of the transmission light after the branching is incident on the optical transmission unit 102 including the second optical output unit 140, and is output to the transmission channel 30 through the second optical output unit 140.

In addition, optical receiving units 202 of the optical receiver 20 share one locally generated light source 204. Specifically, locally generated light emitted by the locally generated light source 204 is branched into a plurality of pieces of locally generated light by an optical branching unit 205. The number of branches is equal to the number of optical receiving units 202. The pieces of the locally generated light after the branching are incident on optical receiving units 202 different from each other. The locally generated light is further branched into two pieces in the inside of each of the optical receiving units 202, and is input to each of a first optical signal generation unit 210 and a second optical signal generation unit 220.

In the present exemplary embodiment, it is also possible to obtain the same effect as that in the second or third exemplary embodiment. In addition, since the transmission light source 104 and the locally generated light source 204 can be shared, it is possible to reduce the cost of the optical transmission system.

### Fifth Exemplary Embodiment

An optical transmission system according to a fifth exemplary embodiment has the same configuration as that in any of the first to fourth exemplary embodiments, except for the configurations of an optical signal processing unit 206 and a denoised signal generation unit 208 of an optical receiver 20.

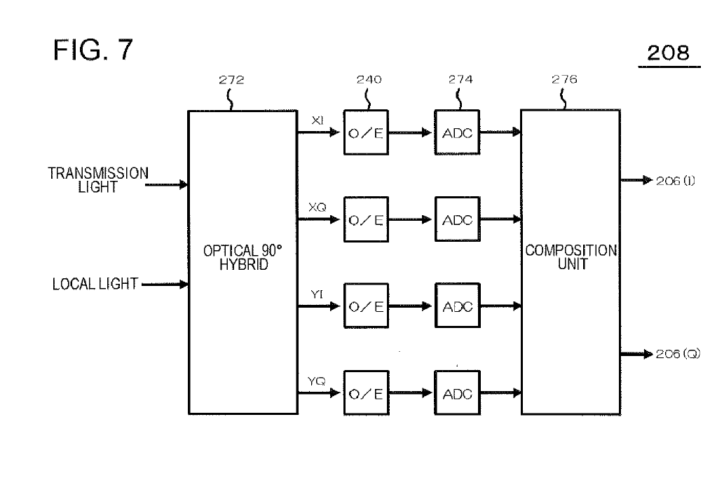

FIG. 7 is a diagram illustrating a functional configuration of the denoised signal generation unit 208 according to the present exemplary embodiment. The denoised signal generation unit 208 according to the present exemplary embodiment includes an optical 90° hybrid 272, a second photoelectric conversion unit 240, an AD conversion unit 274, and a composition unit 276.

Transmission light which is input from a transmission channel 30 and locally generated light are input to the optical 90° hybrid 272. The optical 90° hybrid 272 generates a first one of second optical signals (X_{I} component) by causing the transmission light and the locally generated light to interfere with each other at a phase difference 0, and generates a second one of the second optical signals (X_{Q} component) by causing the transmission light and the locally generated light to interfere with each other at a phase difference π/2. In addition, the optical 90° hybrid 272 generates a third second optical signal (Y_{I} component) by causing the transmission light and the locally generated light to interfere with each other at a phase difference 0, and generates a fourth second optical signal (Y_{Q} component) by causing the transmission light and the locally generated light to interfere with each other at a phase difference π/2. That is, the optical 90° hybrid 272 generates optical signals (first one of the second optical signals and third one of the second optical signals) indicating an I component of noise and optical signals (second one of the second optical signals and fourth one of the second optical signals) indicating a Q component, for each of polarized waves.

The second photoelectric conversion unit 240 photoelectrically converts four noise optical signals generated by the optical 90° hybrid 272, and generates four analog signals. These analog signals are noise signals caused by a frequency difference between a light source for signal light and a light source for locally generated light, and phase noise of each of these light sources.

The AD conversion unit 274 converts (quantizes) each of the four noise signals (first to fourth noise signals) generated by the second photoelectric conversion unit 240 into digital signals. In order to cope with the polarized wave instability of a transmission channel fiber, the second photoelectric conversion unit 240 includes four photoelectric conversion units, but these noise signals have only one polarization component unlike signal light on which polarization multiplexing is performed. For this reason, these four noise signals can be put into a set of I/Q components by the composition unit 276 located behind the AD conversion unit 274. Here, the composition unit 276 uses, for example, a maximum ratio composition system. Specifically, the composition unit 276 composes a first noise signal (X_{I} component) and a third noise signal (Y_{I} component), to thereby generate a first noise signal (I) after composition. In addition, the composition unit 276 composes a second noise signal (X_{Q} component) and a fourth noise signal (Y_{Q} component), to thereby generate a first noise signal (Q) after composition.

The first noise signal (I) after the composition and the second noise signal (Q) after the composition which are generated by the composition unit 276 are output to the optical signal processing unit 206.

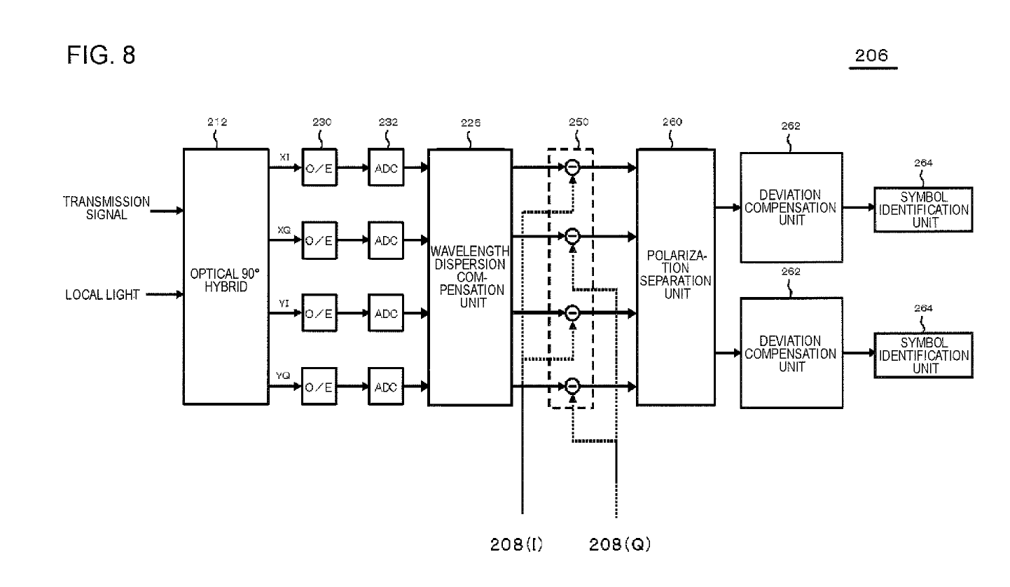

FIG. 8 is a diagram illustrating a functional configuration of the optical signal processing unit 206. The optical signal processing unit 206 includes an optical 90° hybrid 212, a first photoelectric conversion unit 230, an AD conversion unit 232, a wavelength dispersion compensation unit 226, a denoising unit 250, a polarization separation unit 260, a deviation compensation unit 262, and a symbol identification unit 264.

Signal light from the transmission channel and locally generated light are input to the optical 90° hybrid 212. The optical 90° hybrid 212 generates a first one of first optical signals (X_{I}) by causing the optical signal and the locally generated light to interfere with each other at a phase difference 0, and generates a second one of the first optical signals (X_{Q}) by causing the optical signal and the locally generated light to interfere with each other at a phase difference u/2. In addition, the optical 90° hybrid 212 generates a third one of the first optical signals (Y_{I}) by causing the optical signal and the locally generated light to interfere with each other at a phase difference 0, and generates a fourth one of the first optical signals (Y_{Q}) by causing the optical signal and the locally generated light to interfere with each other at a phase difference π/2. The first one of the first optical signals and the second one of the first optical signals form a set of signals, and the third one of the first optical signals and the fourth one of the first optical signals also form a set of signals.

The first photoelectric conversion unit 230 photoelectrically converts four first optical signals generated by the optical 90° hybrid 212, and generates four analog signals (X_{I}, X_{Q}, Y_{I}, and Y_{Q}).

The AD conversion unit 232 converts (quantizes) the four analog signals (X_{I}, X_{Q}, Y_{I}, and Y_{Q}) generated by the first photoelectric conversion unit 230 into digital signals (X_{I}, X_{Q}, Y_{I}, and Y_{Q}).

The wavelength dispersion compensation unit 226 performs a process of compensating for wavelength dispersion applied to the optical signal for transmission in the transmission channel 30, on the four digital signals (X_{I}, X_{Q}, Y_{I}, and Y_{Q}) generated by the AD conversion unit 232.

The polarization separation unit 260 generates signals indicating information transmitted, using the four digital signals (X_{I}, X_{Q}, Y_{I}, and Y_{Q}). Specifically, the polarization separation unit 260 generates 2-channel signals Eₓᵢₙ(t)=X_{I}+jX_{Q} and E_{yin}(t)=Y_{I}+jY_{Q} using the digital signals (X_{I}, X_{Q}, Y_{I}, and Y_{Q}) which are output by the wavelength dispersion compensation unit 226. Eₓᵢₙ(t) and E_{yin}(t) each shows a signal which is transmitted by the optical transmitter 10.

The deviation compensation unit 262 compensates for a frequency deviation and an optical phase deviation between the optical signal for transmission and the local light. Thereby, noise of a signal caused by the rotation of an optical phase is compensated for. The symbol identification unit 264 performs a symbol determination using a signal after being compensated by the deviation compensation unit 262. Thereby, the transmitted signal is demodulated.

The denoising unit 250 is located between the wavelength dispersion compensation unit 226 and the polarization separation unit 260. Specifically, in the denoising unit 250, a difference between the digital signal (X_{I}) and the first noise signal (I) after the composition is calculated, and is input to the polarization separation unit 260 as the digital signal (X_{I}). In addition, a difference between the digital signal (Y_{I}) and the first noise signal (I) after the composition is calculated, and is input to the polarization separation unit 260 as the digital signal (Y_{I}). In addition, a difference between the digital signal (X_{Q}) and the second noise signal (Q) after the composition is calculated, and is input to the polarization separation unit 260 as the digital signal (X_{Q}). In addition, a difference between the digital signal (Y_{Q}) and the second noise signal (Q) after the composition is calculated, and is input to the polarization separation unit 260 as the digital signal (Y_{Q}).

Meanwhile, when the denoised signal generation unit 208 does not include the composition unit 276, the denoising unit 250 performs a process of denoising the digital signal (X_{I}) using the first noise signal, performs a process of denoising the digital signal (X_{Q}) using the second noise signal, performs a process of denoising the digital signal (Y_{I}) using the third noise signal, and performs a process of denoising the digital signal (Y_{Q}) using the fourth noise signal.

As described above, in the present exemplary embodiment, it is also possible to obtain the same effect as that of any of the first to fourth exemplary embodiments. In addition, since the transmission light is a single type of polarized light, the four noise signals (XI, XQ, YI, and YQ) can be put into the noise signal (I) after the first composition and the noise signal (Q) after the second composition. Thereby, it is possible to simplify the transmission channel of a noise signal.

### Sixth Exemplary Embodiment

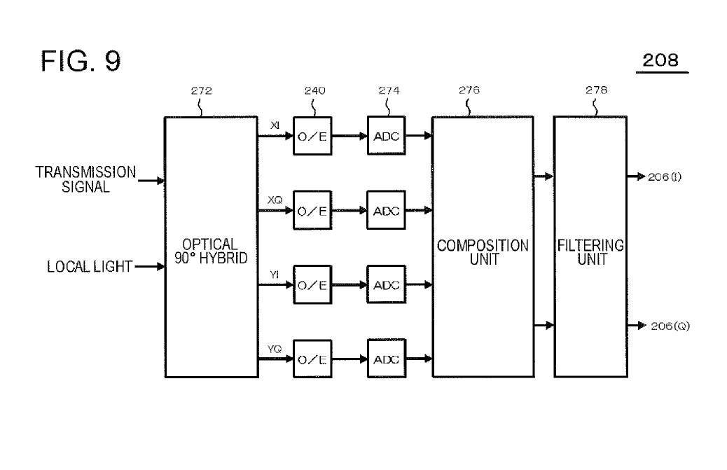

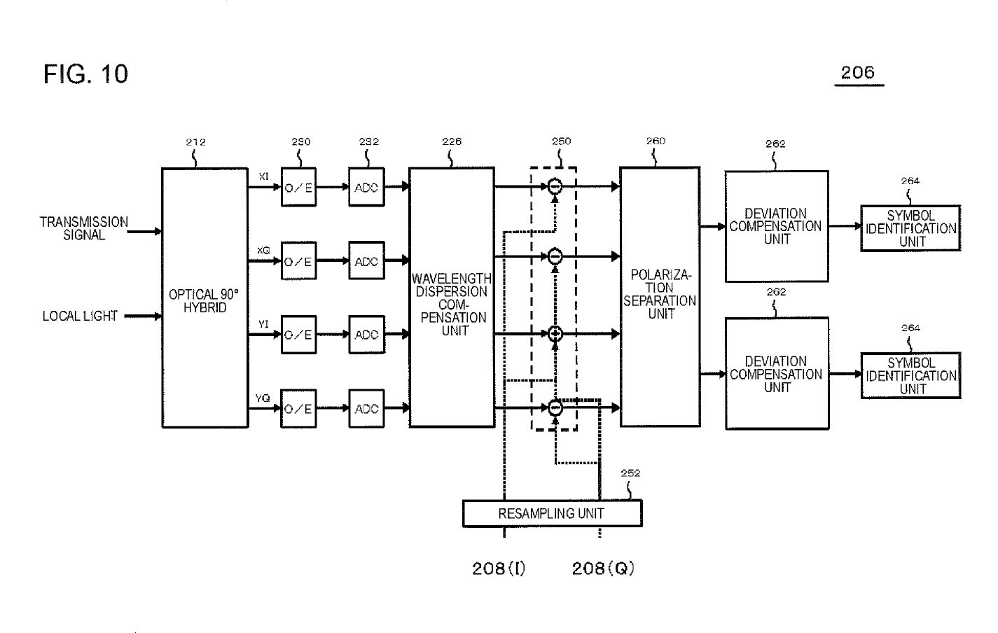

FIG. 9 is a diagram illustrating a functional configuration of a denoised signal generation unit 208 according to a sixth exemplary embodiment. FIG. 10 is a diagram illustrating a functional configuration of an optical signal processing unit 206 according to the sixth exemplary embodiment. An optical transmission system according to the present exemplary embodiment has the same configuration as that of the optical transmission system according to the fifth exemplary embodiment, except for the following points.

First, the denoised signal generation unit 208 includes a filtering unit 278 behind the composition unit 276. The filtering unit 278 passes only an effective frequency band as a noise component out of the first noise signal (I) after the composition and the second noise signal (Q) after the composition. This frequency band is set so as to include, for example, a frequency band in which noise caused by the transmission light source 104 and the locally generated light source 204 has a tendency to be generated, for example, a frequency band of 1 MHz or less.

In addition, in the optical signal processing unit 206, a signal is processed at the frequency of a symbol period (for example, 50 GHz or higher), but in the denoised signal generation unit 208, a process at such a high frequency is not required. That is, the processing frequency of a signal in the denoised signal generation unit 208 can be made lower than the processing frequency of a signal in the optical signal processing unit 206. This allows the circuit configuration of the denoised signal generation unit 208 to be simplified.

The optical signal processing unit 206 includes a resampling unit 252. The resampling unit 252 resamples the first noise signal (I) after the composition and the second noise signal (Q) after the composition at the frequency of signal processing in the optical signal processing unit 206. The denoising unit 250 performs a process using the first noise signal (I) after the composition and the second noise signal (Q) after the composition, after the resampling.

In the present exemplary embodiment, it is also possible to obtain the same effect as that in the fifth exemplary embodiment. In addition, the resampling unit 252 is provided, and thus it is possible to lower the processing frequency of a signal in the denoised signal generation unit 208. Thereby, the circuit configuration of the denoised signal generation unit 208 is simplified.

In addition, the denoised signal generation unit 208 includes the filtering unit 278. Therefore, it is possible to suppress the application of an unnecessary noise signal to the digital signals (X_{I}, X_{Q}, Y_{I}, and Y_{Q}).

As described above, although the exemplary embodiments of the present invention have been set forth with reference to the accompanying drawings, the exemplary embodiments are merely illustrative of the present invention, and various configurations other than those stated above can be adopted.

Meanwhile, examples of reference forms are appended below.

1. An optical transmission system including:

an optical transmitter that generates an optical signal for transmission to output the generated signal to the outside; and

an optical receiver that receives the optical signal for transmission,

wherein the optical transmitter includes

an optical branching unit that branches transmission light for generating the optical signal for transmission into at least two pieces,

an optical signal generation unit that generates the optical signal for transmission by modulating at least one piece of the transmission light after the branching,

a first optical output unit that outputs the optical signal for transmission to the outside, and

a second optical output unit that outputs one piece of the transmission light after the branching to the outside without performing modulation thereon, and

the optical receiver includes

a first optical signal generation unit that receives the optical signal for transmission, and generates a first optical signal by causing the received optical signal for transmission and locally generated light to interfere with each other,

a second optical signal generation unit that receives the transmission light, and generates an optical signal for denoising by causing the received transmission light and the locally generated light to interfere with each other,

a first photoelectric conversion unit that photoelectrically converts the first optical signal to generate a received signal,

a second photoelectric conversion unit photoelectrically converts the optical signal for denoising to generate a noise signal, and

a denoising unit that removes a noise component from the received signal using the noise signal.

2. The optical transmission system according to the above 1, wherein the optical signal generation unit of the optical transmitter generates the optical signal for transmission by performing polarization multiplexing and quadrature amplitude modulation on the transmission light,

the first optical signal generation unit of the optical receiver generates a first one of the first optical signals and a second one of the first optical signals of which a phase is orthogonal to that of the first optical signal, for each of polarized waves, by causing the optical signal for transmission and the locally generated light to interfere with each other using an optical 90° hybrid,

the second optical signal generation unit of the optical receiver generates a first one of second optical signals and a second one of the second optical signals of which a phase is orthogonal to that of the first optical signal, for each of polarized waves, by causing the transmission light and the locally generated light to interfere with each other using an optical 90° hybrid,

the second photoelectric conversion unit generates a plurality of first noise signals by photoelectrically converting the first one of the second optical signals generated for each of the polarized waves, and generates a plurality of second noise signals by photoelectrically converting the second one of the second optical signals generated for each of the polarized waves,

the optical receiver further includes a composition unit that composes the plurality of first noise signals to generate a first noise signal after composition, and composes the plurality of second noise signals to generate a second noise signal after composition, and

the denoising unit removes a noise component of the first one of the first optical signals using the first noise signal after the composition, and removes a noise component of the second one of the first optical signals using the second noise signal after the composition.

3. The optical transmission system according to the above 2, wherein the composition unit generates the first noise signal after the composition and the second noise signal after the composition using a maximum ratio composition system.

4. The optical transmission system according to the above 2 or 3, further including:

a digital processing unit that performs a digital process on the received signal after the denoising unit removes a noise component, a processing frequency of the composition unit being smaller than a processing frequency of the digital processing unit; and

a resampling unit, provided between the composition unit and the denoising unit, which changes frequencies of the first noise signal after the composition and the second noise signal after the composition to the processing frequency of the digital processing unit.

5. The optical transmission system according to any one of the above 1 to 4, wherein the optical branching unit branches the transmission light into three or more pieces,

the optical transmitter includes the optical signal generation unit for each of two or more pieces of the transmission light after the branching, and

the optical receiver includes multiple sets of the first optical signal generation unit, the second photoelectric conversion unit, and the denoising unit,

corresponding to each of the plurality of optical signal generation units.

6. The optical transmission system according to the above 5, wherein the plurality of optical signal generation units share a light source of the transmission light, and

the plurality of first optical signal generation units and the second optical signal generation unit share a light source of the locally generated light.

7. The optical transmission system according to any one of the above 1 to 6, wherein the optical transmitter and the optical receiver are connected to each other using a multi-core fiber, and

the transmission light is transmitted from the optical transmitter to the optical receiver using a core different from that for the signal for transmission.

8. An optical transmitter including:

an optical branching unit that branches transmission light for generating an optical signal into at least two pieces;

an optical signal generation unit that generates an optical signal for transmission by modulating at least one piece of the transmission light after the branching;

a first optical output unit that outputs the optical signal generation unit to the outside; and

a second optical output unit that outputs one piece of the transmission light after the branching to the outside without performing modulation thereon.

9. The optical transmitter according to the above 8, wherein the optical branching unit branches the transmission light into three or more pieces.

10. The optical transmitter according to the above 9, wherein the plurality of optical signal generation units share a light source of the transmission light.

11. An optical receiver including:

a first optical signal generation unit that receives an optical signal for transmission, generated by modulating transmission light, from an outside, and generates a first optical signal by causing the received optical signal for transmission and locally generated light to interfere with each other;

a second optical signal generation unit that receives the transmission light from an outside, and generates an optical signal for denoising by causing the received transmission light and the locally generated light to interfere with each other;

a first photoelectric conversion unit that photoelectrically converts the first optical signal to generate a received signal;

a second photoelectric conversion unit that photoelectrically converts the optical signal for denoising to generate a noise signal; and

a denoising unit that removes a noise component from the received signal using the noise signal.

12. The optical receiver according to the above 11, wherein the first optical signal generation unit generates a first one of the first optical signals and a second one of the first optical signals of which a phase is orthogonal to that of the first optical signal, for each of polarized waves, by causing the optical signal for transmission and the locally generated light to interfere with each other using an optical 90° hybrid,

the second optical signal generation unit generates a first one of second optical signals and a second one of the second optical signals of which a phase is orthogonal to that of the first optical signal, for each of polarized waves, by causing the transmission light and the locally generated light to interfere with each other using an optical 90° hybrid,

the second photoelectric conversion unit generates a plurality of first noise signals by photoelectrically converting the first one of the second optical signals generated for each of the polarized waves, and generates a plurality of second noise signals by photoelectrically converting the second one of the second optical signals generated for each of the polarized waves,

the optical receiver further includes a composition unit that composes the plurality of first noise signals to generate a first noise signal after composition, and composes the plurality of second noise signals to generate a second noise signal after composition, and

the denoising unit removes a noise component of the first one of the first optical signals using the first noise signal after the composition, and removes a noise component of the second one of the first optical signals using the second noise signal after the composition.

13. The optical receiver according to the above 12, wherein the composition unit generates the first noise signal after the composition and the second noise signal after the composition using a maximum ratio composition system.

14. The optical receiver according to the above 12 or 13, further including:

a digital processing unit that performs a digital process on the received signal after the denoising unit removes a noise component, a processing frequency of the composition unit being smaller than a processing frequency of the digital processing unit; and

a resampling unit, provided between the composition unit and the denoising unit, which changes frequencies of the first noise signal after the composition and the second noise signal after the composition to the processing frequency of the digital processing unit.

15. An optical transmission method including:

in an optical transmitter,

branching transmission light for generating an optical signal for transmission into at least two pieces;

generating the optical signal for transmission by modulating at least one piece of the transmission light after the branching, and outputting the generated optical signal for transmission to an optical receiver; and

outputting one piece of the transmission light after the branching to the optical receiver without performing modulation thereon; and

in the optical receiver,

receiving the optical signal for transmission, and generating a first optical signal by causing the received optical signal for transmission and locally generated light to interfere with each other;

receiving the transmission light, and generating an optical signal for denoising by causing the received transmission light and the locally generated light to interfere with each other;

photoelectrically converting the first optical signal to generate a received signal;

photoelectrically converting the optical signal for denoising to a generate noise signal; and

removing a noise component from the received signal using the noise signal.

This application claims priority from Japanese Patent Application No. 2013-051842 filed on Mar. 14, 2013, the content of which is incorporated herein by reference in its entirety.

What is claimed is:

1. An optical transmission system comprising:
an optical transmitter that generates an optical signal for transmission to output the generated signal to the outside; and
an optical receiver that receives the optical signal for transmission,
wherein the optical transmitter includes
an optical branching unit that branches transmission light for generating the optical signal for transmission into at least two pieces,
an optical signal generation unit that generates the optical signal for transmission by modulating at least one piece of the transmission light after the branching,
a first optical output unit that outputs the optical signal for transmission to the outside, and
a second optical output unit that outputs one piece of the transmission light after the branching to the outside without performing modulation thereon, and
wherein the optical receiver includes
a first optical signal generation unit that receives the optical signal for transmission, and generates a first optical signal by causing the received optical signal for transmission and locally generated light to interfere with each other,
a second optical signal generation unit that receives the transmission light, and generates an optical signal for denoising by causing the received transmission light and the locally generated light to interfere with each other,
a first photoelectric conversion unit that photoelectrically converts the first optical signal to generate a received signal,
a second photoelectric conversion unit that photoelectrically converts the optical signal for denoising to generate a noise signal, and
a denoising unit that removes a noise component from the received signal using the noise signal.

2. The optical transmission system according to claim 1,
wherein the optical signal generation unit of the optical transmitter generates the optical signal for transmission by performing polarization multiplexing and quadrature amplitude modulation on the transmission light,
the first optical signal generation unit of the optical receiver generates a first one of the first optical signals and a second one of the first optical signals of which a phase is orthogonal to that of the first one of the first optical signals, for each of polarized waves, by causing the optical signal for transmission and the locally generated light to interfere with each other using an optical 90° hybrid,
the second optical signal generation unit of the optical receiver generates a first one of second optical signals and a second one of the second optical signals of which a phase is orthogonal to that of the first one of the second optical signals, for each of polarized waves, by causing the transmission light and the locally generated light to interfere with each other using an optical 90° hybrid,
the second photoelectric conversion unit generates a plurality of first noise signals by photoelectrically converting the first one of the second optical signals generated for each of the polarized waves, and generates a plurality of second noise signals by photoelectrically converting the second one of the second optical signals generated for each of the polarized waves,
the optical receiver further includes a composition unit that composes the plurality of first noise signals to generate a first noise signal after composition, and composes the plurality of second noise signals to generate a second noise signal after composition, and
the denoising unit removes a noise component of the first one of the first optical signals using the first noise signal after the composition, and removes a noise component of the second one of the first optical signals using the second noise signal after the composition.

3. The optical transmission system according to claim 2,
wherein the composition unit generates the first noise signal after the composition and the second noise signal after the composition using a maximum ratio composition system.

4. The optical transmission system according to claim 2, further comprising:
a digital processing unit that performs a digital process on the received signal after the denoising unit removes a noise component, a processing frequency of the composition unit being smaller than a processing frequency of the digital processing unit; and
a resampling unit, provided between the composition unit and the denoising unit, which changes frequencies of the first noise signal after the composition and the second noise signal after the composition to the processing frequency of the digital processing unit.

5. The optical transmission system according to claim 1,
wherein the optical branching unit branches the transmission light into three or more pieces,
the optical transmitter includes the optical signal generation unit for each of two or more pieces of the transmission light after the branching, and
the optical receiver includes multiple sets of the first optical signal generation unit, the second photoelectric conversion unit, and the denoising unit, corresponding to each of the plurality of optical signal generation units.

6. The optical transmission system according to claim 5,
wherein the plurality of optical signal generation units share a light source of the transmission light, and
the plurality of first optical signal generation units and the second optical signal generation unit share a light source of the locally generated light.

7. The optical transmission system according to claim 1,
wherein the optical transmitter and the optical receiver are connected to each other using a multi-core fiber, and
the transmission light is transmitted from the optical transmitter to the optical receiver using a core different from that for the signal for transmission.

8. An optical transmitter comprising:
an optical branching unit that branches transmission light for generating an optical signal into at least two pieces;
an optical signal generation unit that generates an optical signal for transmission by modulating at least one piece of the transmission light after the branching;
a first optical output unit that outputs the optical signal for transmission to the outside; and
a second optical output unit that outputs one piece of the transmission light after the branching to the outside without performing modulation thereon.

9. An optical receiver comprising:
a first optical signal generation unit that receives an optical signal for transmission, generated by modulating transmission light, from an outside, and generates a first optical signal by causing the received optical signal for transmission and locally generated light to interfere with each other;
a second optical signal generation unit that receives the transmission light from an outside, and generates an optical signal for denoising by causing the received transmission light and the locally generated light to interfere with each other;
a first photoelectric conversion unit that photoelectrically converts the first optical signal to generate a received signal;
a second photoelectric conversion unit that photoelectrically converts the optical signal for denoising to generate a noise signal; and
a denoising unit that removes a noise component from the received signal using the noise signal.

10. (canceled)
